(19) United States
(12) Patent Application Publication
(10) Pub. No.: US 2006/0245021 A1
(43) Pub. Date: Nov. 2, 2006

(54) Multiphoton fluorescence microscope with plane array detector

(76) Inventor: Dan Davidovici, Pfaffenhofen (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/572,888

(22) PCT Filed: Sep. 14, 2004
(86) PCT No.: PCT/EP04/10269

§ 371 Date: Mar. 20, 2006

(30) Foreign Application Priority Data
Sep. 18, 2003 (DE) 10343276.0

(51) Int. Cl. G02B 26/08

(52) U.S. Cl. 359/200

(57) ABSTRACT

A multi-photon fluorescence microscope with an excitation beam path comprising an objective which focuses excitation radiation in a focal point in the sample, a scanning unit which shifts the focal point at least one-dimensionally, and a detecting unit which picks up luminescence radiation stimulated in the sample by multi-photon excitation is described, wherein the detecting unit comprises an area detector which is located on the side of the sample opposite to the objective.

The invention relates to a multi-photon luminescence microscope with an excitation beam path comprising an objective which focuses excitation radiation in a focal point in the sample, a scanning unit which shifts the focal point at least one-dimensionally, and a detecting unit which picks up luminescence radiation stimulated by multi-photon excitation in the sample. The invention further relates to a method of multi-photon luminescence microscopy, wherein excitation radiation is focused in a focal point located in a sample, whereby luminescence radiation is stimulated by multi-photon excitation in the sample and wherein for scanning the sample, the focal point is shifted and the luminescence radiation is detected.

In conventional luminescence microscopy, fluorophores or auto- or self-luminescence are excited in a sample. For this purpose, focused excitation radiation, generally laser radiation, which is tuned for maximum luminescence, is used. Excitation is effected in the focal range, with luminescence being stimulated also in the incident or reflected light cone, respectively, of the focused ray bundle. In order to generate images, the luminescence radiation is picked up by confocal detection only from the region of the excitation radiation focus. An image is generated by scanning a sample.

In multi-photon luminescence microscopy, the excitation radiation is spectrally selected such that at least two photons are required to cause excitation. Since the likelihood of excitation is thus strongly reduced, efficient excitation can only be effected at a very high flux density, which is given only exactly in the point of focus of the focused excitation radiation. Therefore, emission of luminescence radiation or fluorescence radiation is excited only in the focal point. The confocal detection required in conventional luminescence microscopy can be dispensed with, because it is not necessary to block out luminescence radiation which has been emitted outside the focus of the excitation radiation. Multi-photon luminescence microscopy thus works without confocal suppression of stray light during detection. The detectors used are referred to as direct detectors. In this connection, reference is made to the microscopes of BIO-RAD Microscience, USA. The direct detector suggested by the document http:\\microscopy.bio-rad.com/faqs/multophotone/faqs2.htm, which is available on the internet, is a photo multiplier unit also common in confocal microscopy, said unit being coupled into the excitation beam path by a chromatic beam splitter and picking up fluorescence radiation which passes back in a direction opposed to the incidence of the excitation radiation. The photomultiplier tube used in said unit is preceded by a corresponding collective lens which, together with an objective lens present in the excitation beam path, images the sample field completely onto the relatively small window of the highly sensitive photomultiplier tube. Since this has to be done for the entire scan of the sample, a certain optical expenditure is inevitable, in particular because the objective lens used for imaging is also part of the focusing of the laser beam exciting the multi-photon fluorescence. W. Denk et al., “Two-photon molecular excitation in laser scanning microscopy” in “Handbook of Biological Confocal Microscopy”, Plenum Press, New York, 1995, discloses the use of a photomultiplier tube in the transmitted light mode. This is also envisaged in DE 198 01 139, filed in 1998, wherein a condenser is additionally employed, as used by BIO-RAD in the incident light mode.

It is an object of the invention to improve a multi-photon luminescence microscope of the above-mentioned type as well as a corresponding method of multi-photon luminescence microscopy such that radiation detection is possible with less effort.

This object is achieved by a microscope of the above-mentioned type, wherein the detecting unit comprises an area detector, which is located on the side of the sample opposite the objective. The object is further achieved by a method of the above-mentioned type, wherein the luminescence radiation on the side opposite the incidence of the excitation radiation is detected in a flat-spread manner.

Thus, according to the invention, a so-called “direct” detector is used, which is now provided as an area detector located on the side of the sample opposite the objective. An area detector is understood to be any detector whose detector surface is greater than the length of the light path between detector and sample from which the luminescence radiation emerges. By arranging such area detector in the transmitting mode, it is possible, on the one hand, to dispense with intensity-reducing chromatic beam splitters. On the other hand, the area detector can be arranged at a very short distance from the sample, so that it covers a large space angle with respect to luminescence radiation generated in the sample. The area detector used in the transmitting mode receives much more luminescence radiation intensity and thus achieves a better signal/noise ratio; this is also because, in particular, no losses occur due to intermediate optics also used for irradiation of the excitation radiation, such as imaging optics or dichroic beam splitters. Detection of the luminescence radiation need no longer be effected through the objective of the excitation beam path.

In order to cover as large a space angle as possible, it is advantageous that the area detector be spaced apart from the focal point by a distance which is much shorter than the extent of the area detector, for example only a tenth thereof.

In many detectors comprising a planar detection area it is advantageous that the radiation be incident, if possible, perpendicular to said planar detection area, because the detection sensitivity will then be maximal. For signal homogeneization, it is therefore preferred to arrange an optical element between the area detector and the sample, said optical element directing luminescence radiation generated in the sample onto the area detector. In particular, it does not serve to introduce the excitation radiation. In a particularly simple embodiment, the optical element is provided as a grating, preferably as a holographic grating.

In a particularly easy to realize construction, such an optical element is mounted directly to the bottom surface of a sample carrier used in the luminescence microscope.

In luminescence microscopy it is possible to identify biological samples by the spectrum of their auto- or self-luminescence. This procedure is also possible in the luminescence microscope according to the invention, if a spatially resolving area detector is used and a spectral analyzer is interposed between the area detector and the sample, said analyzer spectrally dispersing the radiation emitted by the sample. In a very simple design, the already mentioned grating is arranged between the sample and the area detector for spectral dispersion. For this purpose, the grating or the area detector is coupled with a suitable mechanism, which effects one-dimensional or two-dimensional transverse displacement (with respect to the planar design of the preparation to be examined). Displacement of the grating or of the area detector causes displacement of the interference pattern, which depends on the self- or auto-luminescence spectrum, and thus allows identification of the sample. Alternatively or additionally, the signal-to-noise ratio can be increased, if a known spectral distribution is being searched for.

The invention will be explained in more detail below, by way of example and with reference to the Figures, wherein:

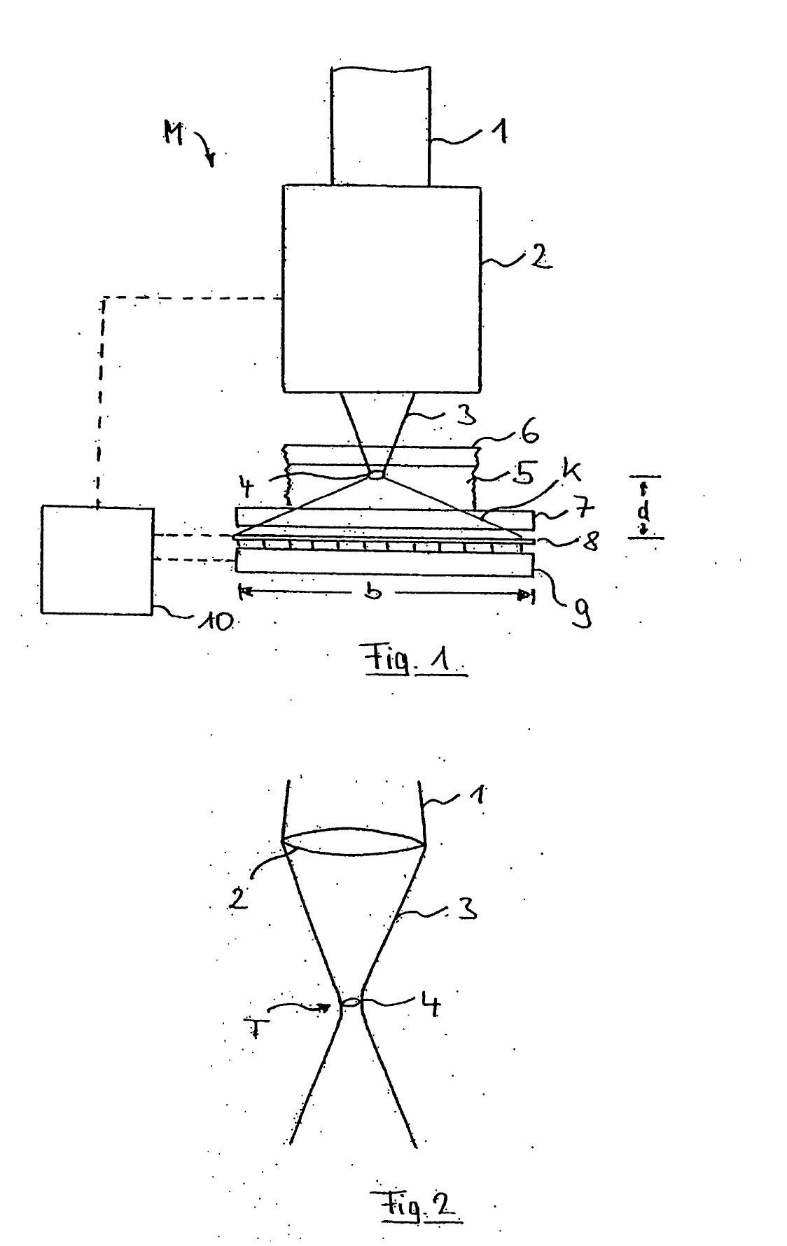

FIG. 1 shows a schematic view of a detail of a microscope for multi-photon fluorescence microscopy and

FIG. 2 shows a schematic view of the laser beam exciting a multi-photon fluorescence.

FIG. 1 schematically shows a microscope M, which allows multi-photon fluorescence microscopy or luminescence microscopy. FIG. 1 only shows that part of the microscope in which the sample is located.

The microscope M comprises a source of radiation (not shown), which emits a laser beam 1 at a wavelength of around 700 nm. The laser beam 1 is incident through an objective 2, which generates a focused beam 3. The focus 4 is located in a sample 5, which is arranged below the objective 2 behind a cover glass 6 on a sample carrier 7.

The laser beam 1 focused into the sample 5 in this manner causes multi-photon excitation in the sample 5, as shown in FIG. 2. In doing so, either an auto- or self-fluorescence of the biological material of the sample 5 or a fluorescence of fluorophores specifically provided in the sample 5 can be excited. The laser beam 1 focused in a beam waist T by the objective, which is shown only schematically in FIG. 2, achieves a beam density sufficient to excite multi-photon fluorescence only in the region of the focus 4. Outside the beam waist T, no multi-photon fluorescence can be excited with sufficient likelihood. Therefore, fluorescence radiation is generated only in the region of the focus 4. No fluorescence occurs in other places in the focused beam 3.

Thus, it may be assumed for the microscope M that fluorescence radiation comes exclusively from the focus 4. Spatially resolved detection of the fluorescence radiation is therefore not required. In order to be able to pick up, to an extend as large as possible, the fluorescence radiation which is homogeneously emitted from the focus 4, a grating 8 is arranged below the sample carrier 7, which grating deflects radiation emitted within a ray cone K onto a CCD sensor 9 such that the radiation is vertically incident on the sensor 9 as far as possible.

The optional grating is located a very small distance d below the focus 4, so that, in combination with the comparatively large extent of the sensor 9 shown only in a sectional view in FIG. 1, a very large space angle is covered with respect to the focus 4.

Since the illustration in FIG. 1 with respect to the thicknesses of the sample 5, of the sample carrier 7 and of the grating 8, in particular with respect to the distance d, is not to scale, but strongly magnified, the unit forming the area detector and consisting of the grating 8 and the sensor 9 collects nearly all fluorescence radiation emitted into a half-space. The signal-to-noise ratio is strongly improved thereby.

The CCD sensor 9, which is provided as a back-illuminated CCD sensor in the present example, supplies the corresponding image information to a control device 10. This device carries out the signal evaluation.

Different approaches may be used in order to block out the excitation radiation 1 also directed onto the detecting unit. On the one hand a sensor 9 may be employed, which is not sensitive with respect to the excitation radiation. On the other hand when pulsed excitation radiation is used, the read-out of the sensor 9 can be limited to periods in which no excitation radiation 1 is emitted. It is also possible to block out or shade off the relatively small portion of the area detector onto which the excitation radiation impinges. This purpose may be served either by a spatially resolving detector which is not read out in the area portion concerned, or by a suitable (possibly adjustable) stop means, which is arranged in front of the sensor 9. A further possibility is the use of a suitable filter or dichroic reflector, which keeps the excitation radiation away from the detector. Of course, these possibilities of suppressing the excitation radiation by temporal or spatial blocking can each be employed alone or in any combination.

In the present exemplary embodiment, a filter for excitation radiation is mounted to the bottom surface of the sample carrier 7 and/or to the grating 8. The filter is an infrared blocking filter which blocks at 700 nm.

It is possible to further improve the signal-to-noise ratio or to obtain additional information, if the grating 8 effects spectral dispersion of the fluorescence radiation entering the ray cone K. For this purpose the control device 10 suitably reads out the sensor 9 (which detects in a spatially resolving manner) and identifies a sample 5 by its self-fluorescence spectrum. The spectral activity of the grating 8 further opens up an additional spectral possibility of blocking out excitation radiation 1, because this radiation clearly differs spectrally from the fluorescence radiation.

As a rule, the grating 8 will generate an interference pattern on the sensor 9. For spectral analysis in one embodiment the control device 10 effects a relative displacement of the grating 8 and sensor 9, so that the interference pattern, which shows the spectral composition of the fluorescence radiation entering the ray cone K (possibly together with excitation radiation 1), changes. The change then enables the control device 10, via algorithms known to the skilled person, to indicate the spectral composition of the fluorescence radiation from the focus 4.

In order to achieve as large a space angle as possible, the distance d should, of course, be as small as possible. In a further embodiment (not shown in FIG. 1), the grating 8 is therefore mounted directly to the bottom surface of the sample carrier 7. Without the grating 8, the distance d (now between the focus 4 and the sensor 9) could be minimized by arranging the sensor as close as possible to the sample carrier 7.

1-8. (canceled)

9. A multi-photon luminescence microscope having an excitation beam path comprising:
an objective which focuses excitation radiation at a focal point in a sample to be excited;
a scanning unit which shifts the focal point at least one-dimensionally; and
a detecting unit which receives luminescence radiation stimulated by multi-photon excitation in the sample, wherein the detecting unit comprises an area detector which is located on a side of the sample opposite the objective.

10. The microscope as claimed in claim 9, wherein the area detector has a longest linear dimension across that is greater than a distance between the focal point and a surface of the area detector.

11. The microscope as claimed in claim 9, wherein the area detector is spaced apart from the focal point by a distance which is small as compared to a longest linear dimension across the area detector such that the area detector covers as large a spatial angle as possible.

12. The microscope as claimed in claim 10, wherein the area detector is spaced apart from the focal point by a distance which is less than about one tenth the longest linear dimension across the area detector.

13. The microscope as claimed in claim 9, wherein a grating is interposed between the area detector and the sample.

14. The microscope as claimed in claim 13, wherein the grating comprises a holographic grating.

15. The microscope as claimed in claim 13, wherein the grating is applied to the bottom surface of a sample carrier.

16. The microscope as claimed in claim 9, wherein the area detector comprises a spatially resolving area detector.

17. The microscope as claimed in claim 16, wherein the area detector comprises a CCD area detector.

18. The microscope as claimed in claim 16, wherein the CCD area detector comprises a back-illuminated CCD sensor.

19. A method of multi-photon luminescence microscopy, comprising:
focusing excitation radiation from an irradiation source at a focal point located in a sample, whereby the sample is excited to emit luminescence radiation stimulated by multi-photon excitation;
scanning the sample by shifting the focal point;
detecting the luminescence radiation on a side of the sample located opposite the irradiation source via an area detector.

20. The method as claimed in claim 19, further comprising spectrally dispersing the luminescence radiation prior to detection.

21. The method as claimed in claim 19, further comprising configuring the area detector such that a longest linear dimension across a surface of the area detector is greater than a distance between the focal point and the surface of the area detector.
